(19) United States
(12) Patent Application Publication
(10) Pub. No.: US 2013/0108819 A1
(43) Pub. Date: May 2, 2013

(54) EXOPOLYSACCHARIDES FOR PREVENTING AND CONTROLLING THE FORMATION OF BIOFILMS

(71) Applicant: Jean Guezennec, Plouzane (FR)

(72) Inventor: Jean Guezennec, Plouzane (FR)

(73) Assignee: IFREMER (INSTITUT FRANCAIS DE RECHERCHE POUR L'EXPLOITATION DE LA MER), Issy-les-Moulineaux (FR)

(21) Appl. No.: 13/806,908

(22) PCT Filed: Jul. 1, 2011
(86) PCT No.: PCT/EP2011/061156

§ 371 Date: Dec. 26, 2012

(30) Foreign Application Priority Data
Jul. 2, 2010 (EP) 10 305 725.3
Aug. 31, 2010 (EP) 10 305 928.3

(51) Int. Cl. C09D 5/00

(52) U.S. Cl. CPC C09D 5/00
USPC 428/36.9; 106/162.1; 428/532; 428/457; 428/474.4; 428/459

(57) ABSTRACT

Exopolysaccharides, preferably obtained by fermenting bacteria from deep hydrothermal ecosystems, serve as agents for preventing the formation of unwanted biofilms on a surface. A method for protecting a surface by preventing the formation of the primary film leading to unwanted biofilms, includes placing the surface in contact with at least one exopolysaccharide, or grafting the exopolysaccharide onto the surface. A method for modifying the physical properties of a surface such that the adhesion of an unwanted bacterial biofilm to the surface is reduced is also described.

### FIELD OF THE INVENTION

The present invention relates to the field of preventing undesirable micro-organism biofilms. More specifically, the invention provides a surface treatment method for protecting said surface against the untimely adhesion of undesirable biofilms, the method according to the invention involving exopolysaccharides. According to the invention, the surface to be treated is placed in contact, from time to time or at regular intervals, with exopolysaccharides, preferably in solution, which are capable of forming a protective film of exopolysaccharides on this surface.

A biofilm is a community of micro-organisms, particularly such as bacteria, fungi, algae or protozoa, adhering together and to a surface. Biofilm production is characterised by the secretion of a matrix capable of adhering to numerous types of surface, particularly minerals, metals, glass, synthetic resins. Biofilms are generally observed in aqueous or wet media.

The adhesion phenomenon of an undesirable biofilm takes place in a plurality of sequences:

1. Formation of a primary film conditioning the surface. This primary film is formed from organic matter present in the medium;

2. Reversible adhesion of the micro-organisms by means of non-covalent or weak chemical bonds;

3. Permanent adhesion of the micro-organisms facilitated by the production of saccharidic exopolymers or of proteins or of glycoproteins acting as anchorage points for subsequent colonisation on a larger scale. The micro-organism film permanently fixed on a surface is the biofilm according to the present invention;

4. In a marine environment, the colonisation of a surface by a biofilm may enable, in the long term, the attachment of higher organisms (barnacles, mussels, and more generally macro-organisms and macro-fouling).

### Technical Problem

Biofilm formation may have many consequences both in the industrial sector and in the environment or health, particularly public health, sectors. The present invention can thus be applied in a variety of fields.

In the industrial sector, biofilms cause corrosion, reduce heat exchange in exchangers and give rise to flow resistance in tubes and pipes. In the health sector, it is acknowledged that biofilms formation could be the source of many cases of nosocomial diseases, particularly if the biofilm fixes on surgical material such as catheters or in air conditioning or refrigeration systems.

The invention particularly relates to the formation of biofilms on any surface liable to be colonised in a natural environment, particularly in a marine environment. In the marine environment, it is known that almost all surfaces immersed in the marine environment are subject to the development of a biofilm. The presence of this biofilm is the source of many problems in the field of oceanography and for marine activities. The means used to control established fouling are frequently toxic (particularly biocides) and may have disastrous consequences on the fauna and flora in the marine environment. Moreover, regular surface cleaning operations increase the running costs of marine industries considerably.

Therefore, there is a genuine need to develop alternative approaches to conventional treatments against fouling and undesirable biofilm.

The present invention is of particular interest in that it acts at the first stages of the adhesion phenomenon, i.e. preventing the formation of a primary film and/or modification of the structure and composition thereof, and preventing reversible adhesion and as such preventing the subsequent permanent undesirable biofilm adhesion stages and then the attachment of macro-organisms onto the biofilm.

### State of the Related Art

Anti-fouling agents are known in the prior art. For example, U.S. Pat. No. 7,090,856 describes an anti-fouling agent which is non-toxic and not harmful for the marine environment. This agent is from Vibrio alginolyticus or Vibrio proteolyticus. It may consist of the supernatant from fermentation of these bacteria, which is subsequently desalinated and generally concentrated. It may be used alone or in paint, concrete or coating compositions. It may be used on marine surfaces in the form of a permanent coating or a spray or rinsing fluid. It inhibits the adhesion of macro-organism larvae, such as barnacles or Polychaeta in particular. However, U.S. Pat. No. 7,090,856 does not describe or suggest an agent for preventing the primary film which is the source of the initially reversible and subsequently permanent adhesion of the micro-organisms. U.S. Pat. No. 7,090,856 likewise does not describe the specific prevention of micro-organism adhesion on surfaces. On the contrary, U.S. Pat. No. 7,090,856 describes the prevention of macro-organism fixation, by means of action on the adhesion of macro-organism larvae on a previously formed undesirable biofilm.

Similarly, patent application EP 1 170 359 describes a biological jelly comprising polysaccharides produced by a strain of the Alteromonas genus. EP 1 170 359 describes that said jelly inhibits the attachment of macro-organisms on a surface. EP 1 170 359 does not describe the prevention of micro-organism adhesion on a surface.

It is know from those skilled in the art that the presence of micro-organisms fixed on a surface is a preliminary requirement for the fixation of macro-organisms on said surface. On the other hand, it is also known that the presence of microscopic biofilm does not automatically give rise to macro-organism fixation. In this way, the absence of macro-organism fixation does not mean that there is no biofilm on a surface. Indeed, EP 1 170 359 describes a surface whereon SHY1-1 bacteria producing a polysaccharide are fixed, said polysaccharide inhibiting the attachment of macro-organisms on said surface.

Moreover, WO9607752 describes polysaccharides from the Hyphomonas family as a metal binding agent, for cleansing waters of said metals.

To the Applicant's knowledge, no prior art document describes or suggests an agent, which is both environmentally friendly and capable of effectively preventing, while respecting the environment completely, the formation of a microscopic primary film or of an undesirable biofilm on a material surface.

### SUMMARY

One object of the present invention is the use of exopolysaccharides (EPS) as an agent for preventing the formation of a microscopic biofilm on a surface.

In one embodiment, said EPS comprise neutral sugars, preferably glucose, rhamnose, mannose or galactose; acid sugars, preferably uronic acids such as glucuronic acid, galacturonic acid or hexuronic acid; amino sugars, preferably N acetyl glucosamine or N acetyl galactosamine; sulphates and/or proteins.

In another embodiment, said EPS are obtained by fermentation of bacteria from deep-sea hydrothermal ecosystems.

In another embodiment, said bacteria from deep-sea hydrothermal ecosystems are of the Alteromonas or Pseudoalteromonas genus.

In another embodiment, said exopolysaccharides are obtained by fermentation of Alteromonas macleodii or Alteromonas infernus bacteria.

In another embodiment, said exopolysaccharides are chosen from HYD 657, HYD 1644, HYD 1545, GY 785, MS 907, ST 716, HYD 721, GY 772, HYD 750, GY 768, GY 788, BI746, GY 786, GY 685, GY 686, ST 719, HYD 1574, HYD 1579, HYD 1582, HYD 1584, ST 708, ST 722, ST 342, ST 349, HYD 1625, and HYD 1666.

In another embodiment, said exopolysaccharides are associated with zosteric acid or any of the derivatives thereof.

In another embodiment, said exopolysaccharides are associated with one or more AMPs.

Another object of the invention is a method for protecting a surface by preventing the formation of a microscopic biofilm, comprising the use of exopolysaccharides as described above, characterised in that a protective exopolysaccharide film is formed on said surface by contacting or grafting said surface with at least one exopolysaccharide.

In one embodiment, said method further comprises a step of monitoring the formation or status of the exopolysaccharide film resulting from contacting or grafting said surface with at least one exopolysaccharide by any suitable physicochemical means.

In another embodiment, said surface is metallic, characterised in that said physicochemical means is the measurement of the variation in electrochemical potential of said surface.

In another embodiment, the contacting is carried out from time to time or at regular intervals, preferably by injecting an EPS solution at a concentration from 0.001 to 10%, preferably 0.01 to 1% by weight to the total volume of the solution, in the vicinity of a surface.

Another object of the invention is a method for modifying the physical characteristics of a surface such that the adhesion of an undesirable bacterial biofilm on said surface is reduced, comprising the use of exopolysaccharides as described above, characterised in that said surface is contacted or grafted with an exopolysaccharide.

Another object of the invention is a surface coated with exopolysaccharides, obtained using exopolysaccharides as described above, or using the method as described above.

Another object of the invention is a product comprising a surface as described above.

In one embodiment, said product is a pipeline or a methane terminal.

In another embodiment, said product is a hospital tool, preferably a tube or a catheter.

### DETAILED DESCRIPTION

The invention thus relates to the use of exopolysaccharides (EPS) as an agent for preventing the formation of undesirable biofilms.

Without wishing to be bound to any theory, the Applicant suggests that the formation of an exopolysaccharide film on a surface modifies the composition and/or the structure of the primary film. The primary film formed in the presence of EPS is hereinafter referred to as the “modified primary film”. In this case, the bacteria of the aqueous medium would be incapable of fixing on this modified primary film. The presence of EPS on the surface would thus inhibit the formation of the microscopic biofilm.

According to one embodiment of the invention, the EPS partially replace the molecules of organic matter in the modified primary film. According to this embodiment, the modified primary film is formed of organic matter and EPS.

According to another embodiment of the invention, the modified primary film consists solely of EPS. According to this embodiment, the EPS are also useful as an agent for preventing the formation, on a surface, of the primary film giving rise to undesirable biofilms.

According to one embodiment of the invention, the EPS used in the present invention comprises neutral sugars, acid sugars, amino sugars, sulphates and/or proteins. According to one embodiment of the invention, the EPS used in the present invention consist of neutral sugars, acid sugars, amino sugars, sulphates and/or proteins.

Examples of neutral sugars include, but are not limited to, glucose, rhamnose, mannose, galactose, etc.

Examples of acid sugars include, but are not limited to, uronic acids and particularly glucuronic acid, galacturonic acid, hexuronic acid such as hexuronic acid having a furan structure substituted on the carbon in position 3 with a lactyl residue, etc.

Examples of amino sugars include, but are not limited to, N acetyl glucosamine and N acetyl galactosamine, etc.

According to one embodiment of the invention, the EPS comprise between 30 and 95% of neutral sugars, preferably between 40 and 90%, more preferentially between 45 and 88% of neutral sugars, in number of sugars to the total number of sugars in the EPS.

According to one embodiment of the invention, the EPS comprise between 1 and 70% of acid sugars, preferably between 5 and 60%, more preferentially between 8 and 53% of acid sugars, in number of sugars to the total number of sugars in the EPS.

According to one embodiment of the invention, the EPS comprise less than 30% of amino sugars, preferably less than 20%, more preferentially less than 12% of amino sugars, in number of sugars to the total number of sugars in the EPS.

According to one embodiment of the invention, the EPS comprise less than 50 sulphate molecules per 100 sugars, preferably less than 40 sulphate molecules, more preferentially less than 35 sulphate molecules per 100 sugars in the EPS.

According to one embodiment of the invention, the EPS comprise less than 50 proteins per 100 sugars, preferably less than 40 proteins, more preferentially less than 37 proteins per 100 sugars in the EPS.

According to one embodiment of the invention, the EPS do not comprise aminoarabinose, a minoribose, heptose and/or xylose.

According to one embodiment of the invention, the EPS used have a molecular weight greater than 500 kDa, preferably greater than 800 kDa, more preferentially greater than 1000 kDa, more preferentially greater than 2000 kDa.

According to a preferred embodiment, the exopolysaccharides (EPS) of the invention are obtained by fermentation of bacteria from deep-sea hydrothermal ecosystems. More specifically, the EPS of the invention are those synthesised under controlled conditions (nutritional imbalance induced by a high Carbon:Nitrogen ratio due to a carbohydrate-enriched nutritional medium) during the fermentation of bacteria from deep-sea hydrothermal ecosystems (see for example Guezennec, J. (2002). Deep-sea hydrothermal vents: A new source of innovative bacterial exopolysaccharides of biotechnological interest? Journal of Industrial Microbiology & Biotechnology 29: 204-208).

According to a first embodiment, these EPS are chosen from HYD 657, HYD 1644, HYD 1545, GY 785, MS 907, ST 716, HYD 721, GY 772, HYD 750, GY 768, GY 788, BI746, GY 786, GY 685, GY 686, ST 719, HYD 1574, HYD 1579, HYD 1582, HYD 1584, ST 708, ST 722, ST 342, ST 349, HYD 1625 and HYD 1666.

According to a second embodiment, these EPS are chosen from those synthesised by bacteria of the Alteromonas or Pseudoalteromonas genus, in accordance with the applicable taxonomic classification on the date of the present invention. Should the taxonomic classification be modified, those skilled in the art could adapt the taxonomic modifications to arrive at the EPS according to the invention. Advantageously, these bacteria are Alteromonas macleodii bacteria, and in this embodiment, preferably the EPS is HYD 657. According to a third embodiment, these bacteria are Alteromonas infernus bacteria, and in this embodiment, preferably the EPS is GY 785. Preferably, the EPS is HYD1545 or HYD1644.

The present invention also relates to a method. The method according to the invention is a method for protecting a surface by preventing the formation of undesirable bacterial biofilm on said surface, wherein a protective exopolysaccharide film is formed on said surface by contacting or grafting said surface with at least one exopolysaccharide according to the invention.

According to a preferred embodiment for carrying out the method of the invention, the EPS are in solution in a polar solvent, preferably water. According to one particular embodiment, the EPS concentration in the solution is from 0.001 to 10%, preferably 0.01 to 1%, very preferentially 0.02 to 0.5%, more preferentially approximately 0.02% by weight/volume, with respect to the total volume of the solution.

Preferably, in the method of the invention, said surface is contacted with an EPS solution as described above.

This contacting or grafting results in the formation of a homogeneous film on said surface. According to one embodiment of the invention, the EPS film is continuous on said surface. According to one embodiment of the invention, the EPS film has a thickness from 0.1 to 100 μm, preferentially 0.5 to 25 μm, preferentially 1 to 10 μm. The conditions promoting the formation of a homogeneous EPS film on the surfaces are preferably as follows:
Temperature between 5 and 30° C., preferably from 10 to 25° C.
Solution from 0.001 to 10%, preferably 0.01 to 1%, very preferentially, 0.02 to 0.5%, more preferentially about 0.02%, i.e. 200 mg/l by weight/volume, with respect to the total volume of the solution.
Contact time from 10 seconds to 5 hours, preferably 1 to 120 minutes, more preferentially 3 to 60 minutes, even more preferentially 5 to 30 minutes.

According to a first embodiment, the contacting is performed in a circulating seawater medium.

According to a second embodiment, the contacting or grafting is carried out prior to the exposure of the surface to the undesirable biofilm formation conditions, for example but not exclusively, prior to immersion in a seawater medium. Preferably, the grafting is performed on small surfaces, such as sensors in particular. Grafting could enable superior EPS stability on the surface than mere contacting, and thus enable longer protection of the grafted surface. The grafting may be carried out by means of any method known to those skilled in the art, particularly such as that described in WO2008078052.

According to the invention, the method may comprise means for monitoring, particularly by means of physicochemical methods, the film-forming potential of the EPS, and the stability thereof over time so as to optimise use and prevent any risk of surface heterogeneity liable to encourage risks, particularly for metal surfaces (metals and alloys), corrosion risks.

According to one particular embodiment, the method according to the invention comprises a step of monitoring the formation of the exopolysaccharide film resulting from the contacting or grafting of said surface with at least one exopolysaccharide according to the invention, by any suitable physicochemical means. In particular, the monitoring of the formation of the EPS film on metal surfaces (metals and alloys) may be measured using electrochemical measurements particular, but not exclusively, by measuring the electrochemical potential of the alloys or metals of the surface, said electrochemical potential and the variation of this potential being measured with respect to a reference electrode.

Indeed, during the contacting of the EPS with the surface and during the formation of the EPS biofilm, the electrochemical potential of the alloys or metals of the surface varies. This electrochemical potential becomes stable when the film is homogeneous. In this way, according to one particular embodiment, when the surface is metallic, the variation in the electrochemical potential of the metal after the first contact with the exopolysaccharides is measured and the contacting of the metal surface with the EPS according to the method according to the invention (contacting with the EPS in solution, or grafting) is continued until the electrochemical potential of the surface stabilises.

According to one particular embodiment of the invention, the measurements are continued, and when the electrochemical potential of the surface destabilises, the contacting with the EPS is resumed until the electrochemical potential stabilises again. Indeed, the alteration of the protective film may induce a variation in this electrochemical potential conveying a risk of bacterial colonisation and, consequently, an obligation to form a further film on said surfaces by contacting with the EPS further. In this way, according to one embodiment, the method according to the invention further comprises a step for monitoring the status of the exopolysaccharide film, for triggering, if required, i.e. if the film is not homogeneous or is degraded, further contacting of the surface with EPS. If the surface is metallic, the destabilisation of the film may be measured and monitored by the variation in the electrochemical potential of the surface.

The invention thus also relates to a method for monitoring the presence of a protective film on a metal surface, wherein the electrochemical potential of said surface is measured. According to one preferred embodiment, a variation of at least −10% of the electrochemical potential of a metal surface over a given time period (1-30 minutes) induces contacting of the surface with EPS again. According to one preferred embodiment of the invention, the apparatus for measuring the electrochemical potential of the surface is coupled with an apparatus for injecting EPS, such that a threshold value prerecorded on the apparatus for measuring the electrochemical potential triggers the contacting of the surface with a given quantity of EPS. According to one prefened embodiment, the contacting is performed by injecting an EPS solution in the vicinity of the surface to be treated.

In this way, according to the method of the invention, the contacting of the EPS with the surface is preferably repeatable, and preferably repeated, particularly on a metal surface when the electrochemical potential of the surface produces a variation of approximately 10%.

The method of the invention results in a significant reduction in bacterial adhesion on the surfaces in question and thus in the formation of the undesirable biofilm.

The Applicant has strong presumptions that the method of the invention has a physical mechanism and that the action of the exopolysaccharides in preventing the primary film is not chemical in nature: in this way, the invention fits in with an environmentally friendly approach and prevents any impact on the bacterial flora.

According to the present invention, the EPS film deposited by the method of the invention modifies the physical characteristics of the surface, for example by modifying the characteristics of the primary film. In this way, the method according to the invention is also a method for modifying the adhesion characteristics of an undesirable bacterial biofilm on a surface, by modifying the physical characteristics of said surface due to the deposition of an exopolysaccharide film. The invention thus relates to a method for modifying the physical characteristics of a surface such that the adhesion of an undesirable bacterial biofilm on said surface is reduced, wherein said physical characteristics of the surface suitable for being modified possibly being: the zeta potential or electrochemical potential; the contact angle; the hydrophilicity; and the Lewis acid-base characteristics.

The present invention is particularly advantageous in that the EPS are completely environmentally friendly, have no antimicrobial effect and are not biocidal.

It should be noted that the present invention is not a means for cleaning a surface or a means for dissolving or fighting against a previously established undesirable bacterial biofilm.

The present invention also relates to a surface coated with an EPS film as described above, or obtained according to the surface protection method as described above. According to one embodiment, said surface is metallic, mineral, such, for example, cements or concretes, or plastic.

The present invention also relates to a product comprising a surface coated with an EPS film as described above.

According to one embodiment, the EPS according to the invention are suitable for use in the industrial sector, such as marine terminals, particularly methane terminals, microbiologically active water pipelines, seawater or fresh water circuits, etc. According to this embodiment, the products comprising a surface coated with an EPS film include, but are not limited to, tubes and conduits of pipelines, platforms, particularly methane terminals.

According to another embodiment, the EPS according to the invention are suitable for use in the health sector, particularly in public health. According to this embodiment, the products comprising a surface coated with an EPS film include, but are not limited to, tubes and catheters, syringes, surgical tools, medical instruments.

According to one embodiment of the invention, the EPS film may be associated with an agent boosting its biofilm formation inhibition action.

According to one embodiment, the agent associated with the EPS film and boosting the biofilm formation inhibition action thereof is zosteric acid. Zosteric acid is described as enabling the prevention of biofilm formation on surfaces (U.S. Pat. No. 5,384,176, U.S. Pat. No. 5,607,741, incorporated by reference herein).

According to one embodiment, the zosteric acid is native. According to another embodiment, the zosteric acid may be a chemically modified derivative, preferentially a zosteric acid derivative is a zosteric acid ester as described in US2007/128151, incorporated by reference herein. According to one preferred embodiment, the zosteric acid derivative is an acidic zosteric acid derivative.

According to one embodiment, the zosteric acid is extracted from the alga Zostera marina.

According to another embodiment of the invention, the EPS film may be associated with antimicrobial agents, such as, for example, antimicrobial peptides (AMPs). According to this embodiment, the EPS film associated with the antimicrobial agents has antimicrobial effects, suitable for accentuating the surface colonisation inhibition effect. Such an activity is particularly useful in the health sector.

Antimicrobial peptides (AMPs) are innate immunity effector molecules, preserved in the course of evolution and widespread through the realm of living beings. A wide variety of AMPs has been identified in recent years, revealing great diversity in terms of structures, sizes and modes of action. AMPs are generally characterised by a high representation of cationic and hydrophobic amino acids. These molecules are most frequently amphiphilic in nature which is essential for the interaction thereof with bacterial membranes (Bulet et al. 2004). AMPs kill micro-organisms either by permeabilising the membrane thereof by means of a detergent effect or by the formation or pores, or by blocking the synthesis of peptidoglycan forming the bacterial wall, or by inhibiting bacterial metabolic pathways (Brodgen et al., 2005).

Compared to the chemical antibiotics generally used, AMPs offer the advantage of being completely biodegradable. They are emerging as good candidates for substituting conventional chemical antibiotics, due to the biological properties thereof. Indeed, they offer a broad spectrum of antimicrobial activity, low specificity, various modes of action and safety for the environment.

AMPs may be produced by chemical synthesis or by recombinant bacterial or yeast system expression (cloning, expression, purification).

According to one embodiment of the invention, AMPs may belong to the alpha helix linear AMP family, the AMP family with over-representation of one or a plurality of amino acids, the beta Hairpin AMP family with 1 or 2 disulphide bridges, the beta sheet and alpha helix cyclic AMP family with 3 or more disulphide bridges (Bulet et al., Immunological reviews, 2004, 198: 169-184; Brogden, Nature Review Microbiology, 2005, 3:238-250).

Examples of linear alpha helix AMPs includes, but are not limited to, cecropin, stomoxyn, ponericin, spinigerin, oxyopinin, cupiennin, clavanin, styelin, pardaxin, misgurin, pleurocidin, parasin, oncorhyncin, moronecidin, magainin, temporin, cathelicidin and indolicidin.

Examples of AMPs enriched with one or a plurality of amino acids, proline, arginine, glycine or tryptophan include, but are not limited to, bactenicins, PR-39, abaecins, apideacins, drosocin, pyrrhocoricins, Cg-Prp, prophenin and indolicin. Examples of hairpin AMPs containing 2 to 4 cysteines include, but are not limited to, tachyplesin, protegrin, thanatin, androctonin, gomesin, polyphemusin, hepcidin, brevinin, esculentin, tigerinin or bactenecin.

Examples of cyclic AMPS containing 6 or more cysteine residues or having an open cycle include, but are not limited to, defensins (of vertebrates, invertebrates or plants), termicin, heliomycin, drosomycin, ASABF, pBD, penaedins, ALF and big-defensins.

According to one preferred embodiment of the invention, the AMP is tachyplesin or a defensin.

According to one embodiment of the invention, the AMPs are synthesised by chemical synthesis. According to another embodiment of the invention, the AMPs are synthesised by biological synthesis in a bacterial or fungal recombinant system and preferably, in a yeast system.

According to one embodiment, the surface coated by the EPS film is contacted with a solution comprising one or more AMPs at a concentration of 1 to 10 MIC.

According to the invention, the AMPs may be in solution in a biologically acceptable polar solvent such as water, ethanol, trifluoroethanol (CF₃CH₂OH, TFE) or a mixture thereof such as water/TFE, preferably trifluoroethanol (CF₃CH₂OH).

According to one embodiment of the invention, the contacting is carried out at a constant temperature, preferentially from 1 to 10° C., more preferentially about 4° C.

According to one embodiment of the invention, contacting is carried out from 24 to 120 hours, preferentially from 48 to 96 hours, more preferentially 72 hours.

### DEFINITIONS

The term EPS refers to exopolysaccharides synthesised under controlled conditions (nutritional imbalance induced by a high Carbon:Nitrogen ratio due to a carbohydrate-enriched nutritional medium) during the fermentation of bacteria from deep-sea hydrothermal ecosystems, particularly but not exclusively, the following EPS:

| EPS | | Neutral | Acid | Amino | | Pro- |
|---|---|---|---|---|---|---|
| reference | Source | sugars | sugars | sugars | Sulphates | teins |
| HYD 657 | Deep-sea | 58 | 30 | 0 | 5 | 2 |
| | hydro- | | | | | |
| | thermal | | | | | |
| HYD 1644 | as above | 38 | 32 | 0 | 10 | 5 |
| HYD 1545 | as above | 49 | 34 | 0 | 11 | 1 |
| GY 785 | as above | 51 | 37 | 0 | 6 | 4 |
| MS 907 | as above | 50 | 37 | 0 | 0 | 0 |
| ST 716 | as above | 46 | 41 | 2 | 5 | 4 |
| HYD 721 | as above | 57 | 11 | 0 | 8 | 3 |
| GY 772 | as above | 43 | 50 | 2 | 0 | 3 |
| HYD 750 | as above | 44 | 16 | 2 | 5 | 16 |
| GY 768 | as above | 37 | 37 | 2 | 8 | 2 |
| GY 788 | as above | 30 | 28 | 3 | 8 | 5 |
| BI746 | as above | 34 | 18 | 6 | 8 | 4 |
| GY 786 | as above | 37 | 32 | 4 | 5 | 6 |
| GY 685 | as above | 61 | 8 | 1 | 11 | 2 |
| GY 686 | as above | 46 | 8 | 2 | 15 | 7 |
| ST 719 | as above | 56 | 10 | 3 | 18 | 7 |
| HYD 1574 | as above | 66 | 9 | 1 | 13 | 3 |
| HYD 1579 | as above | 52 | 8 | 4 | 13 | 3 |
| HYD 1582 | as above | 49 | 12 | 3 | 16 | 9 |
| HYD 1584 | as above | 52 | 10 | 4 | 14 | 8 |
| ST 708 | as above | 49 | 8 | 1 | 10 | 12 |
| ST 722 | as above | 49 | 8 | 3 | 13 | 8 |
| ST 342 | as above | 42 | 7 | 2 | 17 | 18 |
| ST 349 | as above | 50 | 5 | 2 | 9 | 16 |
| HYD 1625 | as above | 46 | 40 | 2 | 13 | 4 |
| HYD 1666 | as above | 48 | 36 | 1 | 10 | 6 |

The relative compositions of these EPS are given in the table below:

| EPS | Neutral | Acid | Amino | | |
|---|---|---|---|---|---|
| reference | sugars¹ | sugars¹ | sugars¹ | Sulphates² | Proteins² |
| HYD 657 | 65.91 | 34.09 | 0 | 5.68 | 2.27 |
| HYD 1644 | 54.29 | 45.71 | 0 | 14.29 | 7.14 |
| HYD 1545 | 59.04 | 40.96 | 0 | 13.25 | 1.20 |
| GY 785 | 57.95 | 42.05 | 0 | 6.82 | 4.55 |
| MS 907 | 57.47 | 42.53 | 0 | 0 | 0 |
| ST 716 | 51.69 | 46.07 | 2.25 | 5.62 | 4.49 |
| HYD 721 | 83.82 | 16.18 | 0 | 11.76 | 4.41 |
| GY 772 | 45.26 | 52.63 | 2.11 | 0 | 3.16 |
| HYD 750 | 70.97 | 25.81 | 3.23 | 8.06 | 25.81 |
| GY 768 | 48.68 | 48.68 | 2.63 | 10.53 | 2.63 |
| GY 788 | 49.18 | 45.90 | 4.92 | 13.11 | 8.20 |
| BI746 | 58.62 | 31.03 | 10.34 | 13.79 | 6.90 |
| GY 786 | 50.68 | 43.84 | 5.48 | 6.85 | 8.22 |
| GY 685 | 87.14 | 11.43 | 1.43 | 15.71 | 2.86 |
| GY 686 | 82.14 | 14.29 | 3.57 | 26.79 | 12.50 |
| ST 719 | 81.16 | 14.49 | 4.35 | 26.09 | 10.14 |
| HYD 1574 | 86.84 | 11.84 | 1.32 | 17.11 | 3.95 |
| HYD 1579 | 81.25 | 12.50 | 6.25 | 20.31 | 4.69 |
| HYD 1582 | 76.56 | 18.75 | 4.69 | 25 | 14.06 |
| HYD 1584 | 78.79 | 15.15 | 6.06 | 21.21 | 12.12 |
| ST 708 | 84.48 | 13.79 | 1.72 | 17.24 | 20.69 |
| ST 722 | 81.67 | 13.33 | 5 | 21.67 | 13.33 |
| ST 342 | 82.35 | 13.73 | 3.92 | 33.33 | 35.29 |
| ST 349 | 87.72 | 8.77 | 3.51 | 15.79 | 28.07 |
| HYD 1625 | 52.27 | 45.45 | 2.27 | 14.77 | 4.55 |
| HYD 1666 | 56.47 | 42.35 | 1.18 | 11.76 | 7.06 |

¹the relative quantities are given as a % of sugars with respect to the total number of sugars in the EPS
²the relative quantities are given as a number of molecules per 100 sugars in the EPS.

The term “EPS solution” refers to a solution formed of a polar solvent, and an EPS or EPS mixture.

The term “surface” refers to the surface area, or the external part of a material mass which may be of synthetic origin, typically a polymeric material or a material of mineral origin, typically glass or concrete, or which may be a metal, particularly copper, titanium; the preferred metal surfaces are 316L stainless steel, titanium, Inconel 600, nickel, admiralty brass and chromium.

The term “primary film” refers to a conditioning film formed of proteins or protein fragments, carbohydrates, lipids, mineral materials such as, for example, mineral salts from the surrounding medium. This primary film stimulates bacterial adhesion.

The term “undesirable biofilm” refers to a film of micro-organisms, generally bacteria, which fix onto the primary film, in a first reversible and subsequently irreversible adhesion step. Within the scope of the present invention, a biofilm is formed of micro-organisms. The terms “biofilm”, “microscopic biofilm”, “bacterial biofilm” and “undesirable biofilm” are interchangeable. In this way, macro-organisms fixed on a surface do not form a biofilm according to the present invention.

The term “grafting” refers to any means for fixing EPS according to the invention onto the surface.

The term “contact angle” refers to the angle at which a liquid interface meets a solid surface. The contact angle is measured by a goniometer. The contact angle measurement accounts for the capability of a liquid of spreading over a surface. The method consists of measuring the angle of the tangent of the profile of a drop deposited on the material, with the surface of the material. It makes it possible to measure the surface energy of the liquid or solid. The contact angle measurement makes it possible to access the free energy of a surface. It also makes it possible to discriminate the polar or apolar nature of the interactions at the liquid/solid interface. The hydrophilic or hydrophobic nature of a surface can thus be deduced.

The term “MIC” refers to the minimum concentration from which an agent inhibits visible growth of a micro-organism after incubation overnight. The methods for determining the MIC of an agent are well-known in the prior art.

The following examples describe particular embodiments of the invention, illustrating the invention in a non-limiting fashion.

### BRIEF DESCRIPTION OF THE FIGURE

FIG. 1, which is read with reference to example 1 hereinafter, is a graph illustrating the film-forming potential of the EPS, with the x-axis indicating the experimentation time, i.e. the exposure time of the film-coated and non-film-coated surfaces to circulating seawater, and the y-axis indicating the surface coverage rate with EPS.

### EXAMPLES

### Example 1

### Effectiveness of EPS in Reducing Undesirable Bacterial Biofilm Contamination

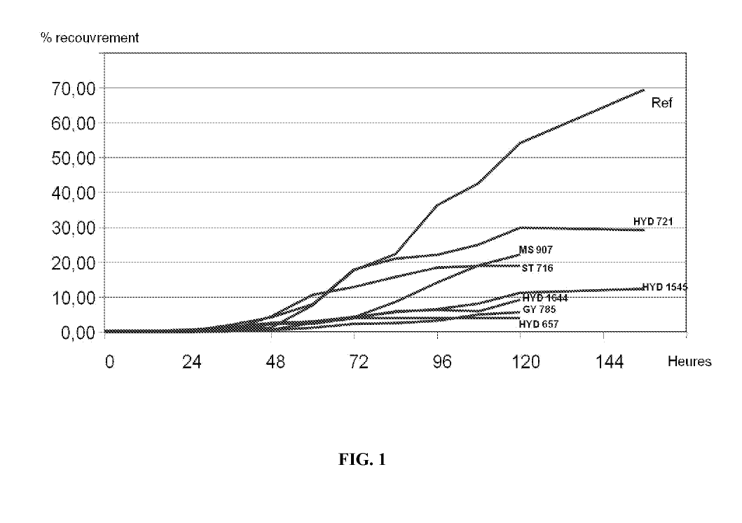

Numerous EPS were tested. FIG. 1 contains the results obtained with the following EPS: HYD 721, MS 907, ST 716, HYD 1545, HYD 1644, GY 785 and HYD 657. The general method is explained with reference to the following 4 EPS:

HYD 657

GY 785

HYD1545

HYD1644

These EPS are known in the prior art, and particularly described in the following publications:
(HYD 657): Carnbon-Bonavita M. A., G. Raguénès, J. Jean, P. Vincent and J. Guézennec. (2002). A novel polymer produced by a bacterium isolated from a deep-sea hydrothermal vent polychaete annelid. Journal of Applied Microbiology, 93, 310-315,
(GY 785): Raguénès G, Peres A, Ruimy R, Pignet P, R Christen R, Loaec M, Rougeaux H, Barbier G and Guezennec, J. (1997). Alteromonas infernus sp. nov, a new polysaccharide producing bacterium isolated from a deep-sea hydrothermal vent. J. Appl. Bacteriol. 82: 422-430,
(HYD 1545): Vincent, P., Pignet, P., Talmont F, Bozzi, L., Fournet, B., Milas, M., Guezennec, J., Rinaudo M and Prieur, D. (1994). Production and characterization of an exopolysaccharide excreted by a deep-sea hydrothermal vent bacterium isolated from the polychaete Alvinella pompejana. Appl. Environ. Microbiol. 60(11): 4134-4141,
(HYD 1644): Dubreucq G, Domon B, Fournet B (1996) Structure determination of a novel uronic acid residue isolated from the exopolysaccharide produced by a bacterium originating from deep-sea hydrothermal vents. Carbohydr Res 290: 175-181,
Guezennec, J. (2002). Deep-sea hydrothermal vents: A new source of innovative bacterial exopolysaccharides of biotechnological interest? Journal of Industrial Microbiology & Biotechnology 29: 204-208.

Experiments:

316L stainless steel samples were used for the studies on the influence of pre-treatment of surfaces with biopolymers obtained from fermentation of bacteria. The steel samples were pre-conditioned by immersing in osmosis-purified water supplemented with proteins and/or bacterial exopolysaccharides obtained from biotechnological fermentation methods at a concentration of 200 mg/litre (i.e. 0.02% weight/volume). After two hours of contact at a constant temperature of 20° C., the various samples were rinsed with 200 ml of physiological water and dried under a laminar flow hood before testing. Non-pre-conditioned samples were used as references.

Dynamic mode adhesion tests were conducted using non-replenished circulating seawater. The bacterial colonisation of the non-conditioned and conditioned samples with various exopolysaccharides was monitored using an electron microscope equipped with a camera connected to a computer and using dynamic adhesion cells.

Pre-conditioning of the surfaces with some exopolysaccharides gave rise to substantial reductions in the coverage percentage of the substrates (316L stainless steel) tested. After 120 hours of testing and without repeating the conditioning by adding further exopolymers into the experimental system, the contamination rates (bacterial coverage) remained between 5 and 10%.

In this way, these measurements made in circulating natural seawater demonstrated surface (316L stainless steel and glass) coverage rates with marine bacteria of less than 10% after 6 days of exposure without replenishing the biofilm, compared to a reference value of 70% in the absence of a polysaccharide film.

### Example 2

### Test Demonstrating the Lack of Antimicrobial Activity of the EPS Film

Principle:

A diluted bacterial culture is contacted in microwells, with an EPS solution at known concentrations. The result is obtained by measuring the optical density (OD) in the wells after 18 hours of growth at 30° C. The minimum inhibitory concentration (MIC) is the lowest concentration at which the EPS inhibits bacterial growth. The minimum bactericidal concentration (MBC) is the lowest concentration at which the EPS kills bacteria.

Method:

The tests were conducted on 3 bacteria:
Escherichia coli SBS 363 (Gram-negative bacillus)
Micrococcus luteus CIP 53.45 (Gram-positive coccus)
Pseudomonas sp (marine strain)

A first screening was conducted on all the EPS at a high concentration (100 or 500 μg/ml) to detect potentially active EPS. A second test was conducted with dilution series of active EPS to detect the MIC. The content of the wells showing an inhibition was spread on an agar medium to detect the MBC.

Results: No EPS was Found to be Active.

| | | Antibacterial activity (MIC μg/ml) | | |
|---|---|---|---|---|
| | | E. coli | | M. luteus |
| | Test | SBS | Pseudomonas | CIP |
| EPS | concentrations | 363 | sp. | 5345 |
| GY 785 | 100 μg/ml | >100 | >100 | >100 |
| HYD | 100 μg/ml | >100 | >100 | >100 |
| 1545 | | | | |
| HYD | 100 μg/ml to 1 ng/ml | >100 | >100 | >100 |
| 1644 | | | | |
| HYD 657 | 500 and | >500 | >500 | >500 |
| | 100 μg/ml | | | |

### Results Summary Table

### Example 3

### Second Test Demonstrating that the Eps Film is not Biocidal

Principle:

A diluted bacterial culture is contacted in microwells, with an EPS solution at known concentrations. The result is obtained by measuring the optical density (OD) in the wells after 18 hours of growth at 30° C. The minimum inhibitory concentration (MIC) is the lowest concentration at which the EPS inhibits bacterial growth. The minimum bactericidal concentration (MBC) is the lowest concentration at which the EPS kills bacteria.

Method:

The tests were conducted on 4 bacteria and 1 yeast:
Escherichia coli ATCC 8739 (Gram-negative bacillus)
Bacillus subtilis ATCC 6633 (Gram-positive bacillus)
Pseudomonas aeruginosa ATCC 9027 (Gram-negative bacillus)
Staphylococcus aureus ATCC 6538 (Gram-positive coccus)
Candida albicans ATCC 10231 (yeast)

Each EPS was placed in solution in sterile water at 1 mg/ml and diluted to 0.5 mg/ml and 0.25 mg/ml. These solutions were used to conduct antimicrobial tests at the final concentrations 100 μg/ml, 50 μg/ml and 25 μg/ml.

The content of the wells demonstrating an inhibition was spread on agar culture medium to determine the MBC.

Results:

At the test concentrations, the strains grow in the presence of any EPS.

| | | Antibacterial activity (MIC μg/ml) | | | | |
|---|---|---|---|---|---|---|
| | | | Bacillus | | | Candida |
| | Test | Escherichia | subtilis | Pseudomonas | Staphylococcus | albicans |
| | concentrations | coli ATCC | ATCC | aeruginosa | aureus | ATCC |
| EPS | (μg/ml) | 8739 | 6633 | ATCC 9027 | ATCC 6538 | 10231 |
| GY | 100-50-25 | >100 | >100 | >100 | >100 | >100 |
| 785 | | | | | | |
| HYD | 100-50-25 | >100 | >100 | >100 | >100 | >100 |
| 1545 | | | | | | |
| HYD | 100-50-25 | >100 | >100 | >100 | >100 | >100 |
| 1644 | | | | | | |
| HYD | 100-50-25 | >100 | >100 | >100 | >100 | >100 |
| 657 | | | | | | |

1-17. (canceled)

18. Method for preventing the formation of a microscopic biofilm on a surface, comprising applying exopolysaccharides (EPS) on said surface.

19. Method according to claim 18, wherein said EPS comprise neutral sugars, preferably glucose, rhamnose, mannose or galactose; acid sugars, preferably uronic acids such as glucuronic acid, galacturonic acid or hexuronic acid; amino sugars, preferably N acetyl glucosamine or N acetyl galactosamine; sulphates and/or proteins.

20. Method according to claim 18, wherein said EPS are obtained by fermentation of bacteria from deep-sea hydrothermal ecosystems.

21. Method according to claim 18, wherein said EPS are obtained by fermentation of bacteria from deep-sea hydrothermal ecosystems, wherein said bacteria from deep-sea hydrothermal ecosystems are of the Alteromonas or Pseudoalteromonas genus.

22. Method according to claim 18, wherein said exopolysaccharides are obtained by fermentation of Alteromonas macleodii or Alteromonas infernus.

23. Method according to claim 18, wherein said exopolysaccharides are chosen from HYD 657, HYD 1644, HYD 1545, GY 785, MS 907, ST 716, HYD 721, GY 772, HYD 750, GY 768, GY 788, BI746, GY 786, GY 685, GY 686, ST 719, HYD 1574, HYD 1579, HYD 1582, HYD 1584, ST 708, ST 722, ST 342, ST 349, HYD 1625, and HYD 1666.

24. Method according to claim 18, wherein said exopolysaccharides are associated with zosteric acid or any of the derivatives thereof.

25. Method according to claim 18, wherein said exopolysaccharides are associated with one or more AMPs.

26. Method for protecting a surface by preventing the formation of a microscopic biofilm according to claim 18, comprising forming a protective exopolysaccharide film on said surface by contacting or grafting said surface with at least one exopolysaccharide.

27. Method according to claim 26, further comprising a step of monitoring the formation or status of the exopolysaccharide film resulting from contacting or grafting said surface with at least one exopolysaccharide by any suitable physicochemical means.

28. Method according to claim 26, wherein said surface is metallic, and wherein said physicochemical means is the measurement of the variation in electrochemical potential of said surface.

29. Method according to claim 26, wherein the contacting is carried out from time to time or at regular intervals, preferably by injecting an EPS solution at a concentration from 0.001 to 10%, preferably 0.01 to 1% by weight to the total volume of the solution, in the vicinity of a surface.

30. Method for modifying the physical characteristics of a surface such that the adhesion of an undesirable bacterial biofilm on said surface is reduced, comprising contacting or grafting said surface with an exopolysaccharide.

31. Method according to claim 30, wherein said EPS comprise neutral sugars, preferably glucose, rhamnose, mannose or galactose; acid sugars, preferably uronic acids such as glucuronic acid, galacturonic acid or hexuronic acid; amino sugars, preferably N acetyl glucosamine or N acetyl galactosamine; sulphates and/or proteins.

32. Method according to claim 30, wherein said EPS are obtained by fermentation of bacteria from deep-sea hydrothermal ecosystems.

33. Method according to claim 30, wherein said EPS are obtained by fermentation of bacteria from deep-sea hydrothermal ecosystems, wherein said bacteria from deep-sea hydrothermal ecosystems are of the Alteromonas or Pseudoalteromonas genus.

34. Method according to claim 30, wherein said exopolysaccharides are obtained by fermentation of Alteromonas macleodii or Alteromonas infernos.

35. Method according to claim 30, wherein said exopolysaccharides are chosen from HYD 657, HYD 1644, HYD 1545, GY 785, MS 907, ST 716, HYD 721, GY 772, HYD 750, GY 768, GY 788, BI746, GY 786, GY 685, GY 686, ST 719, HYD 1574, HYD 1579, HYD 1582, HYD 1584, ST 708, ST 722, ST 342, ST 349, HYD 1625, and HYD 1666.

36. Method according to claim 30, wherein said exopolysaccharides are associated with zosteric acid or any of the derivatives thereof.

37. Method according to claim 30, wherein said exopolysaccharides are associated with one or more AMPs.

38. Surface coated with exopolysaccharides (EPS).

39. Surface according to claim 38, wherein said EPS comprise neutral sugars, preferably glucose, rhamnose, mannose or galactose; acid sugars, preferably uronic acids such as glucuronic acid, galacturonic acid or hexuronic acid; amino sugars, preferably N acetyl glucosamine or N acetyl galactosamine; sulphates and/or proteins.

40. Surface according to claim 38, wherein said EPS are obtained by fermentation of bacteria from deep-sea hydrothermal ecosystems.

41. Surface according to claim 38, wherein said EPS are obtained by fermentation of bacteria from deep-sea hydrothermal ecosystems, wherein said bacteria from deep-sea hydrothermal ecosystems are of the Alteromonas or Pseudoalteromonas genus.

42. Surface according to claim 38, wherein said exopolysaccharides are obtained by fermentation of Alteromonas macleodii or Alteromonas infernos.

43. Surface according to claim 38, wherein said exopolysaccharides are chosen from HYD 657, HYD 1644, HYD 1545, GY 785, MS 907, ST 716, HYD 721, GY 772, HYD 750, GY 768, GY 788, BI746, GY 786, GY 685, GY 686, ST 719, HYD 1574, HYD 1579, HYD 1582, HYD 1584, ST 708, ST 722, ST 342, ST 349, HYD 1625, and HYD 1666.

44. Surface according to claim 38, wherein said exopolysaccharides are associated with zosteric acid or any of the derivatives thereof.

45. Surface according to claim 38, wherein said exopolysaccharides are associated with one or more AMPs.

46. Product comprising a surface according to claim 38.

47. Product according to claim 46, wherein said product is a pipeline or a methane terminal.

48. Product according to claim 46, wherein said product is a hospital tool, preferably a tube or a catheter.
